(19) United States
(12) Patent Application Publication
(10) Pub. No.: US 2019/0163684 A1
(43) Pub. Date: May 30, 2019

(54) METHOD AND SYSTEM FOR CONVERTING DATA INTO A SOFTWARE APPLICATION COMPATIBLE FORMAT

(71) Applicant: Craig Hurlbut, Webster, NY (US)

(72) Inventor: Craig Hurlbut, Webster, NY (US)

(21) Appl. No.: 16/204,035

(22) Filed: Nov. 29, 2018

Related U.S. Application Data
(60) Provisional application No. 62/592,813, filed on Nov. 30, 2017.

(51) Int. Cl. G06F 16/25; G06F 16/84; G06F 17/22; G06F 17/27; G06K 9/00; G06K 9/20; H04N 1/04

(52) U.S. Cl. CPC G06F 16/258; G06F 16/86; G06F 17/2217; G06K 2209/01; G06K 9/00442; G06K 9/2063; H04N 1/04; G06F 17/2705

(57) ABSTRACT

A method automatically converts an electronic portable document format file of image data into an electronic format compatible for importing into a database by creating, using a user input interface, within an electronic portable document format file of image data, parsing demarcations; converting the portable document format file of image data into an electronic comma separated values file of ASCII characters, based upon the created demarcations; identifying labels and data corresponding to each identified labels; associating the identified data with the corresponding identified label; and pushing the associated identified data with the corresponding identified label into a database.

### PRIORITY INFORMATION

This application claims priority from U.S. Provisional Patent Application, Ser. No. 62/592,813, filed on Nov. 30, 2017. The entire content of U.S. Provisional Patent Application, Ser. No. 62/592,813, filed on Nov. 30, 2017, is hereby incorporated by reference.

### COPYRIGHT

A portion of the disclosure of this patent document contains material which is subject to copyright protection. The copyright owner has no objection to the facsimile reproduction by anyone of the patent document or patent disclosure, as it appears in the Patent and Trademark Office patent file or records, but otherwise reserves all copyright rights.

### BACKGROUND

Many conventional accounting software applications offer features to record accounting transactions, balance a bank statement, invoice customers, pay vendors, payroll, budgeting, financial statements, and many other related tasks. With estimates of 20-25 million small businesses in the U.S., there is always a large demand for other features or tasks not offered by the conventional accounting software applications. Customers may use conventional accounting software applications for certain business applications and other software applications or services for other tasks.

For example, a user may use accounting software application A for accounting and Service B for payroll because the user wants payroll to be secured and off-site.

In another example, a user may use accounting software application A for accounting and software application C for invoicing customers

As a result there is a consistent demand to transfer data to and from the accounting software applications. This data can be grouped into two types: (1) lists—a static list of vendors, customers, accounts that changes relatively seldom; and (2) transactions—daily accounting transactions like paying bills, invoicing customers, etc.

If a user is using accounting software application A and another software application B to run a business, it is likely the user may be required to transfer transactions between the two software packages regularly. Lists may need to be updated, but much less often.

Conventionally, some accounting software applications have provided a method of formatting data in a file for the purpose of importing data (both transactions and lists) into the accounting software application.

Many of these file formats are relatively difficult to use and have not been updated since the software application's initial release. In these cases, since these file formats have been the only methods to import data into the conventional accounting software applications, third party software companies have had to deal with it by providing users with the ability to create the formatted files.

For example, a payroll company may allow its customers to download a formatted file containing payroll transactions for the purpose of importing to a specific accounting software application. The customer's objective is to have all financial transactions in the accounting software application in order to have accurate financial statements.

Banks may allow customers to download banking transactions in a formatted file to import into the accounting software application.

A user may adopt the accounting software application in the middle of the year. The user wishes to have all their lists and transactions from earlier in the year, from their prior software, transferred into the newly chosen accounting software application in order to have a complete year in the newly chosen accounting software application. The user may need to find a way to create a formatted file out of their prior software.

Another issue that arises is when an existing accounting software application is re-vamped such that the formatted files associated with the pre-re-vamped accounting software application are no longer compatible for importing. This can cause a negative impact to existing users who switch over to the new software application but are using applications or services which only produce the old formatted files and do not produce the formatted files compatible for importing.

In a further situation, as illustrated in FIG. 4, a user may adopt a new accounting software application after seven months into the fiscal year and want to combine the financial data from the old software application and the financial data from the new software application into a single file to facilitate the preparation of tax returns, end of year financial statements, etc. The user may need to find a way to create a single formatted file from the two software application sources.

In addition, the outsourcing of services, relating to management of a company's data, whether it is payroll data or personnel data, is a growing trend. Although outsourcing can help a business streamline its costs, outsourcing presents hidden costs should the business decide to change providers.

One such issue is that the current provider may be managing the data with proprietary software applications that rely on the data being formatted in a distinct manner.

When switching to a new provider utilizing different proprietary software applications that rely on the data being formatted in a different manner, the data must be converted to the new format before it is imported into the new proprietary software application.

This conversion is conventionally done in a manual manner and has a cost associated therewith. This cost is the actual manhours needed to perform the conversion as well as the errors that may occur in the conversion process.

This cost is usually bore by the business seeking the switching of providers, but the new provider may bear it by taking this cost into account when pricing their services. Thus, in the end, the business seeking the switch bears the costs, directly or indirectly through the pricing structure of the service.

Thus, it is desirable to provide a solution that provides the necessary conversion functionality, without relying upon a manual conversion process, at a lower cost and efficiency.

Furthermore, it is desirable to provide a solution that bridges the production of previous generation formatted files with the new format constraints for import compatibility.

### BRIEF DESCRIPTION OF THE DRAWINGS

The drawings are only for purposes of illustrating various embodiments and are not to be construed as limiting, wherein:

FIG. 1 illustrates a block diagram of a system for formatting data from one software application source into a format compatible for importing into another software application;

FIGS. 2 and 3 illustrate a flowchart showing the conversion of data from one format to another format;

FIG. 4 illustrates an issue when utilizing two different formats;

FIG. 5 illustrates an interactive window on a display screen that incorporate the format conversion functionality into a conventional spreadsheet application;

FIG. 6 illustrates a relationship between data tables and a database;

FIG. 7 illustrates a relationship between original format and new format;

FIG. 8 illustrates an example of a vendor table generated by the conversion process;

FIG. 9 illustrates the process of transferring the spreadsheet data to a new application;

FIG. 10 illustrates a first portion of Table A showing raw data from a PDF conversion;

FIG. 11 illustrates a second portion of Table A showing raw data from a PDF conversion;

FIG. 12 illustrates a third portion of Table A showing raw data from a PDF conversion;

FIG. 13 illustrates a fourth portion of Table A showing raw data from a PDF conversion;

FIG. 14 illustrates a first portion of Table B showing examples of data Items from the payroll industry;

FIG. 15 illustrates a second portion of Table B showing examples of data Items from the payroll industry;

FIG. 16 illustrates Table C showing examples of coordinates and values needed from a specific payroll register; and

FIG. 17 illustrates Table D showing an example of an output.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

In the following description, accounting software application refers to any software application directed to accounting, payroll processing, bookkeeping, invoice processing, account payable processing, accounts receivable processing, bill payment processing, timekeeping, and/or other business based financial processes.

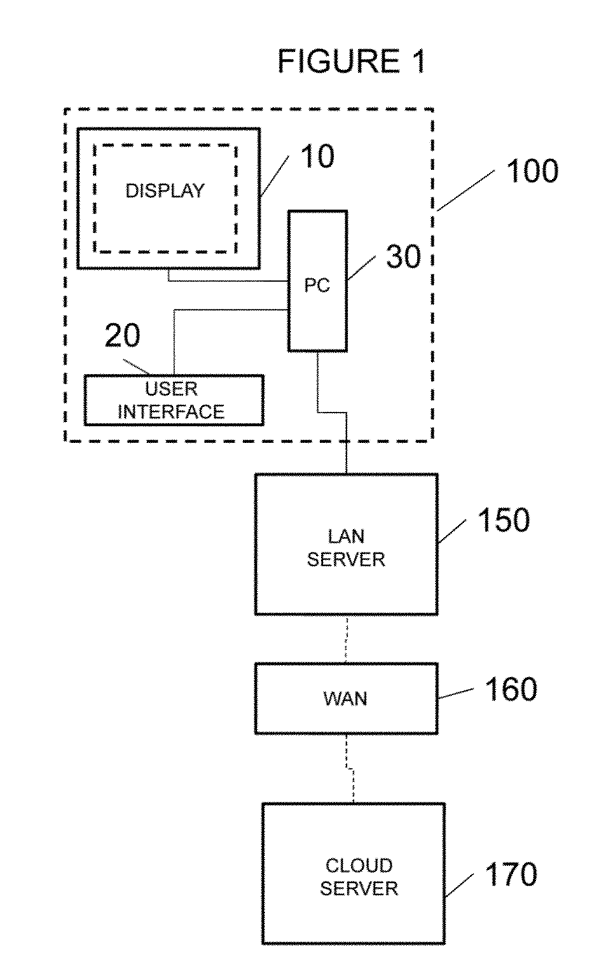

FIG. 1 illustrates a system for formatting data from one software application source into a format compatible for importing into another software application.

As illustrated in FIG. 1, the system includes a client computing system 100. The client computing system 100 includes a display device or screen 10, a computing device 30 (having a processor, memory, and various input/output interfaces), and user interface 20 (such as a keyboard, mouse, or other type of pointing device).

The client computing system 100 may be connected to a server 150 through a local area network. The server 150 has a processor, memory, various input/output interfaces, etc.

The accounting application software may reside upon the client computing system 100 and/or the server 150. Also, the data file for the accounting application software may reside upon the client computing system 100 and/or the server 150.

Moreover, the client computing system 100 and the server 150 may be connected to an internet (cloud) server 170 through a wide area network 160.

In this situation, the accounting application software may reside upon the client computing system 100, the server 150, and/or the internet (cloud) server 170. Also, the data file for the accounting application software may reside upon the client computing system 100, the server 150, and/or the internet (cloud) server 170.

In formatting data from one accounting software application source into a format compatible for importing into another accounting software application, the user, using the client computing system 100, opens a spreadsheet application which has been modified with an extension that allows the user to pull data from an accounting software application. The user also opens the accounting software application from which data is to be pulled.

In this modified spreadsheet application, the display device 10 may display an activatable icon within the spreadsheet application's window that can be activated by the user interface 20.

FIG. 5 illustrates an example of the spreadsheet application having activatable icons 200. As illustrated in FIG. 5, the display device 10 displays a spreadsheet application's window 11 that has activatable icons 200, for activating extensions, and a spreadsheet work area 300.

It is noted that one of the activatable icons 200, upon activation, launches (initiates) the extension which enables transfer of data from the accounting software application to the spreadsheet work area 300.

More specifically, the initiated extension electronically connects the initiated extension with the launched accounting software application, through an application program interface of the launched accounting software application to create an electronic data channel between the initiated extension and the launched accounting software application.

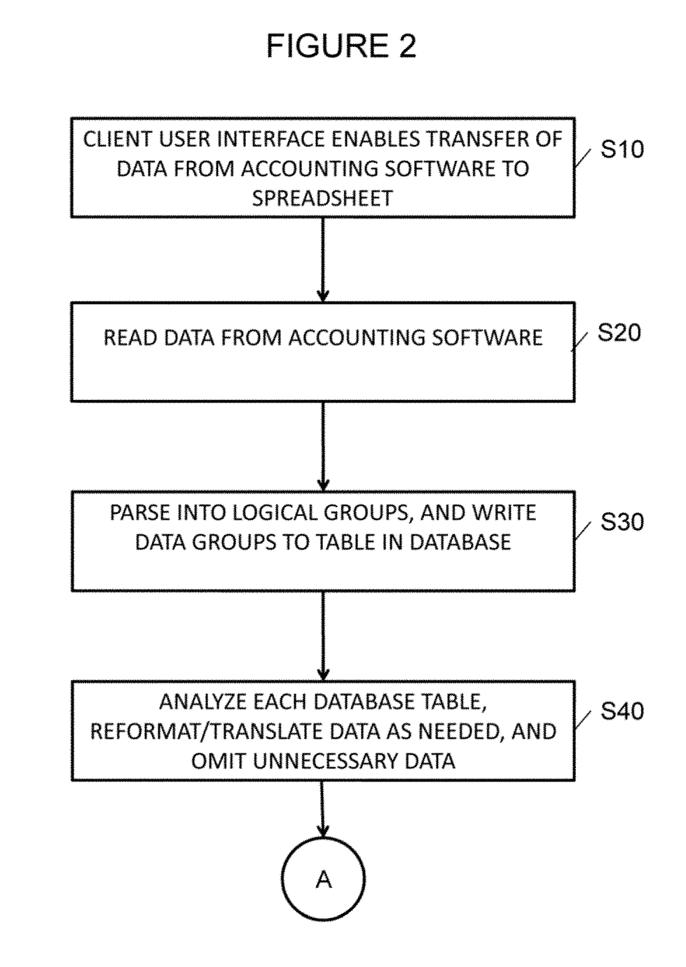

As illustrated in FIG. 2, the user interface 20 enables transfer of data from the accounting software application to spreadsheet, at step S10. At step S20, the activated spreadsheet extension pulls data from the opened accounting software application.

It is noted that if the accounting software application needs user authentication, the extension enables the user to enter the appropriate authentication data (passwords, etc.) so that the data file associated with the accounting software application can be accessed.

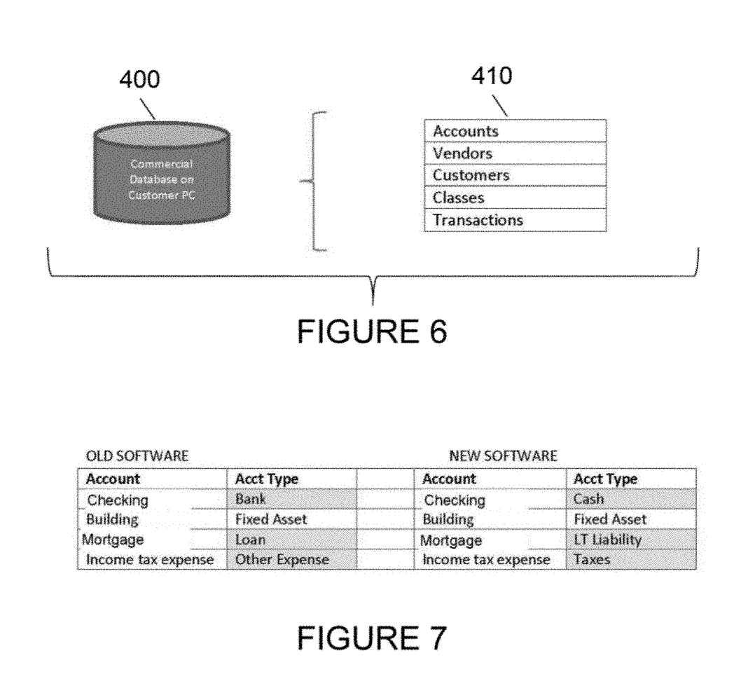

At step S30, the pulled data is parsed into logical groups and the groups are written into a table in a database, as illustrated in FIG. 6. An example of a program that can facilitate the pulling, parsing, and writing of data, as discussed above, is Datablox™.

At step S40, each database table is analyzed and the data is reformatted or translated as needed. Unnecessary data can also be omitted in this step.

As illustrated in FIG. 7, the initial data may have an account type as “Bank.” However, when the database is analyzed at step S40, the process recognizes that the new accounting software application does not have “Bank” as an account type. Based upon this recognition, step S40 replaces (translates) “Bank” to “Cash” as the account type.

Furthermore, as illustrated in FIG. 7, the initial data may have an account type as “Loan.” However, when the database is analyzed at step S40, the process recognizes that the new accounting software application does not have “Loan” as an account type. Based upon this recognition, step S40 replaces (translates) “Loan” to “LT Liability” as the account type.

In addition, as illustrated in FIG. 7, the initial data may have an account type as “Other Expense.” However, when the database is analyzed at step S40, the process recognizes that the new accounting software application has an account type specifically directed to the account “Income tax expense.” Based upon this recognition, step S40 replaces (translates) “Other Expense” to “Taxes” as the account type.

It is noted that the opened accounting software application may use classes to categorize income and expenses for a single job or project. If the new accounting software application has a similar feature, but calls it projects, the class names may be translated to project names.

In analyzing the data pulled from the accounting software application, the process may utilize pre-determined maps (tables) that enable the mapping of the original account type of the original accounting software application to the new account type of the accounting software application.

For example, in the situation described above with respect to the account type “Bank,” the process may include a table entry that maps “Bank” to “Cash.”

It is noted that the extension may be transfer specific wherein the extension has pre-determined maps (tables) that enable the mapping of the original account type of the original accounting software application A to new accounting software application B.

It is also noted that the extension may have multiple pre-determined maps (tables), each associated with a specific transfer, such that the extension acquires from the user the identity of the original accounting software application and the identity of the new accounting software application and based upon the acquired identity information, the extension chooses the correct pre-determined maps (tables) to use in the analysis/translation routine.

It is further noted that dates (mm/yy/dd) and phone numbers (###-###-####) are often stored in different formats. Step S40 may reformat data in order for it to transfer successfully to the new accounting software application.

With respect to omitting data, if the opened accounting software application captures more data fields than the new accounting software application, the additional fields may be omitted at step S40.

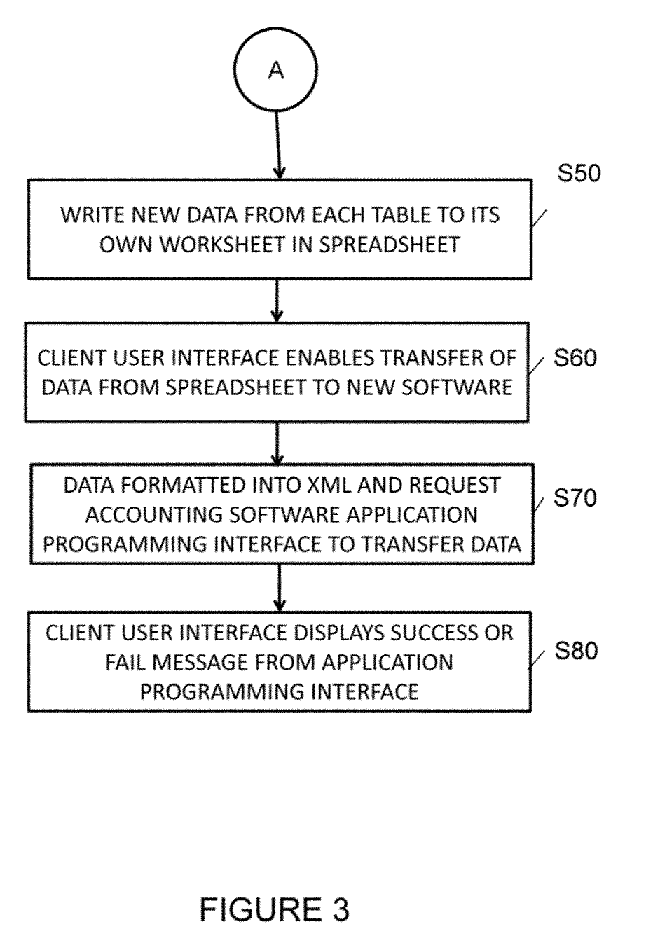

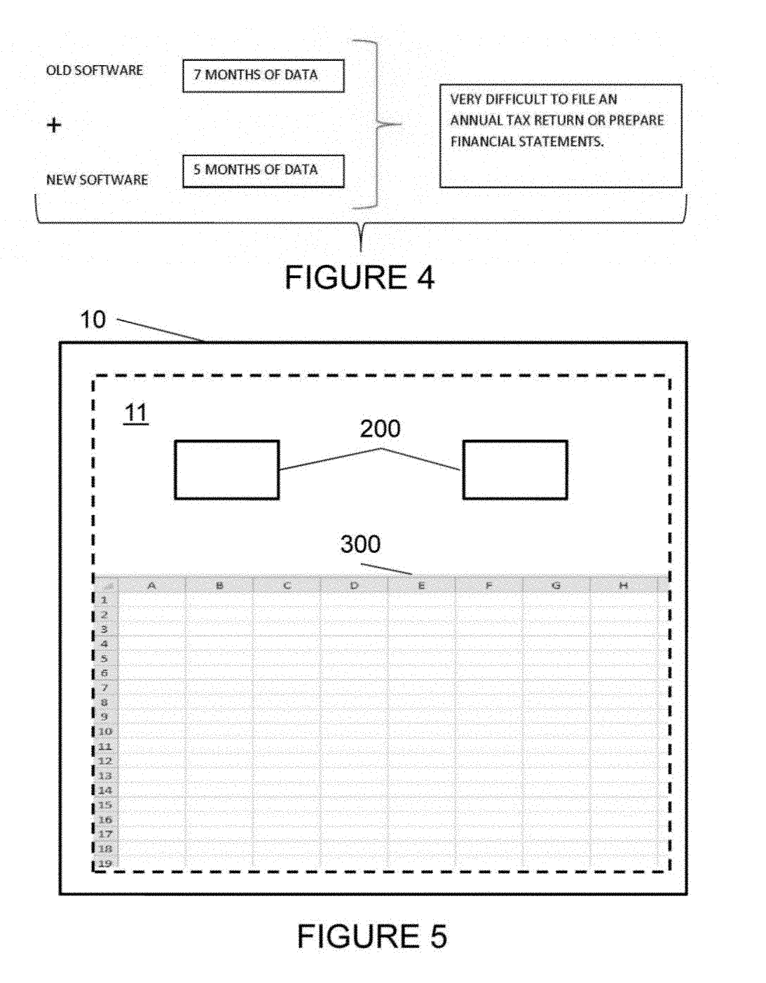

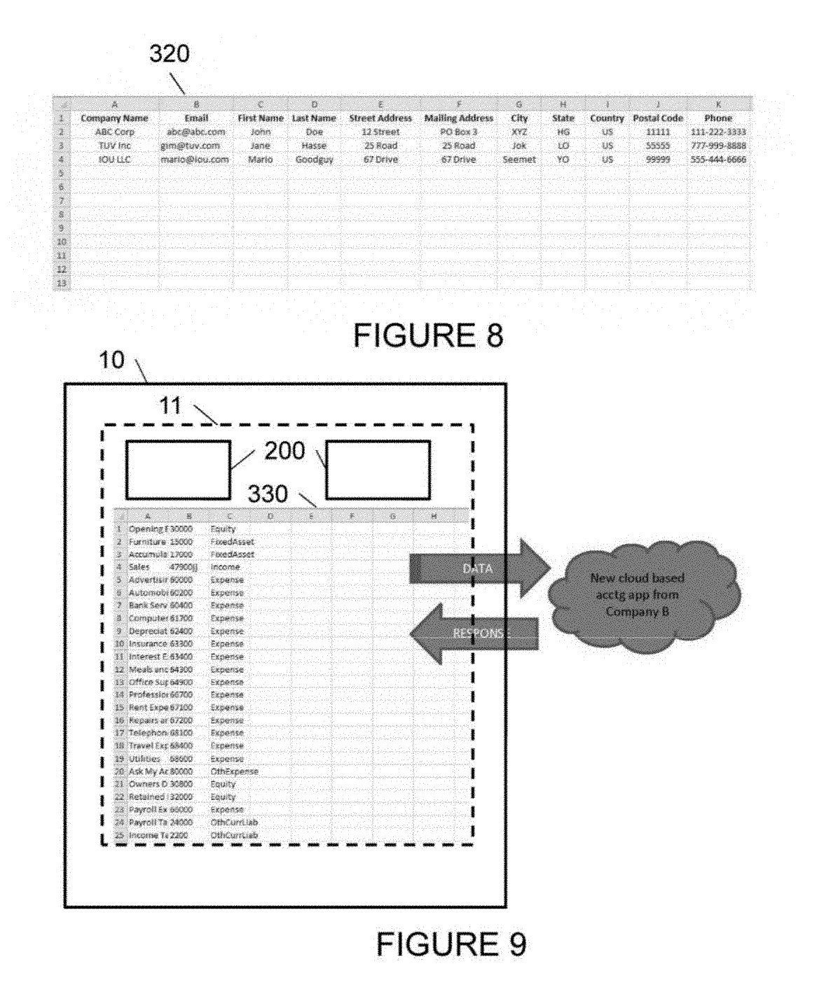

In FIG. 3, at step S50, the new “data” is written from each table to its own worksheet in the spreadsheet. FIG. 8 illustrates an example of a vendor worksheet created from a vendor table having the new “data.”

After the new data is written into the spreadsheet, the user can review and/or edit the data before the data is transferred to the new accounting software application. It is also noted that the spreadsheet can be saved for future reference.

As noted above, in the modified spreadsheet application, the display device 10 may display an activatable icon within the spreadsheet application's window that can be activated by the user interface 20.

It is noted that one of the activatable icons 200 of FIG. 5, upon activation, launches the extension which enables transfer of data from the spreadsheet work area 300 to an accounting software application (step S60 of FIG. 3).

More specifically, the initiated extension electronically connects the initiated extension with the launched accounting software application, through an application program interface of the launched accounting software application to create an electronic data channel between the initiated extension and the launched accounting software application.

Upon activation of the extension for enabling transfer of data from the spreadsheet work area 300 to an accounting software application, at step S70, the data in spreadsheet is formatted into a format that is acceptable to the new accounting software application. For example, the data in spreadsheet is formatted into XML.

At step S70, the extension makes a request of the application program interface of the new accounting software application to transfer the formatted data to the new accounting software application.

At step S80, the client computing device may display a message from the new accounting software application indicating a successful transfer or a failed transfer.

FIG. 9 illustrates the transfer of the formatted data to the new accounting software application and a response indicating the state of the transfer.

In the description above, the extension provides a software bridge (user interface in the sense that a user uses the software platform as a bridge to interface between the two accounting software applications), which can readily accept the previous generation formatted files and effectively re-format the data for importing into the new generation accounting software application. The software bridge (user interface) may be ubiquitous in that the software bridge is readily available, easy to use, and has the ability to interface with numerous applications and platforms.

An example of a possible software platform to use in generating a software bridge is Microsoft™ spreadsheet software, Excel™, because Excel™ is readily available, easy to use, and has the ability to interface with numerous applications and platforms. It is also noted that in many cases, Excel™ has built-in wizards which provide ways of importing different types of file formats.

The software platform used to create the bridge (user interface) may be based upon a programming language that enables an extension of its capabilities.

For example, Microsoft™ provides a programming language Visual Basic for Applications that extends the capability of Excel™. By programming in Visual Basic for Applications, one can create an Excel™ Add-In for a user that provides custom features. The user can run the Visual Basic for Applications program by selecting menu options or buttons right from the Excel™ menu. The benefit of an Excel™ Add-In is the user can work within Excel™ and its familiar interface. The Add-In can act on data the user has entered and saved in Excel™. The user does not need to learn new software. Installing an Add-In takes just a few clicks.

It is noted that although Microsoft™ spreadsheet software, Excel™ has been discussed above, any software platform (application) that is readily available, easy to use, has the ability to interface with numerous applications and platforms, and is based upon a programming language that enables an extension of its capabilities can be utilized.

The Add-In feature of Excel™ may transfer (export) only journal entries into the accounting software application. A journal entry is one type of transaction that is commonly entered into an accounting software application. However, there are many other types of transactions and lists that a user might possibly want to transfer to the accounting software application.

For example, the Add-In feature of Excel™ may transfer (export) bills, invoices, purchase orders, checks, bank deposits, and/or estimates.

To summarize, the software bridge transfers data from directly within the software bridge to any accounting software application that offers the necessary interface(s). The data can represent any type of financial transaction that an accounting software user might want to transfer.

The software bridge “pushes” the data from within the software bridge to the new accounting software application rather than have the data “pulled” or “imported” to the new accounting software application because the “pull” approach is much more difficult for a user because the user must comply with the data format required by the new accounting software application, or the new accounting software application may not permit importing.

However, it is noted that the user may have to pull or import the data into the new accounting software application if the new accounting software application does not have an application program interface which enables the pushing of data from the software bridge to the new accounting software application.

The following description is an example of a software bridge, using Microsoft™ spreadsheet software, Excel™, as the platform and Intuit™ QuickBooks™ Online or QuickBooks™ Desktop, as the accounting software.

In the following description, it is assumed that the user has data in Excel™ to be transferred to QuickBooks™ Online or QuickBooks™ Desktop.

When executing an Add-In feature of Excel™ (created according to the described concepts), the user should have Excel™ open with the data to be transferred appearing in the active sheet.

By clicking an Add-In feature of Excel™; for example, XLtoQB; two buttons may be displayed for activation—either an IIF format button or a Columnar format button depending upon the initial format of the data that the user wishes to export to QuickBooks™ Online or QuickBooks™ Desktop.

For first-time users, clicking either button may begin a setup process that is discussed in more detail below.

For users having completed the setup, clicking one of the buttons button will execute a Visual Basic for Applications code. An example of such source code (Source Code 1) is provided below.

Upon clicking one of the buttons, a pop-up window is displayed.

The pop-up window may include a “Login to QuickBooks” button, which when it is clicked, another windows is displayed showing an Intuit™ prompt for the QuickBooks™ Online or QuickBooks™ Desktop username and password.

This window enables the user to sign into QuickBooks™ Online. If a user has multiple companies, a user may select any of the companies. The extension may display a window notifying the user that the extension has successfully connected to QuickBooks™ Online or QuickBooks™ Desktop if the sign in data was acceptable.

The following is an example of source code for an Excel™ Add-in which provides a software bridge for transferring data formatted in the Intuit™ Interchange Format (IIF) format to QuickBooks™ Online or QuickBooks™ Desktop.

Source Code 1 takes transaction data in Excel™ and transfers it to a desktop version of QuickBooks™ or an online version of Quickboks™ using the QuickBooks™ Software Developer Kit.

For example, if a customer has a payroll transaction file to transfer to a desktop version of QuickBooks™ or an online version of Quickboks™, the customer can utilize Source Code 1, as set forth below, to take payroll transaction data in Excel™ and transfer it to a desktop version of QuickBooks™ or an online version of Quickboks™.

The following source code is subject to copyright protection. The copyright owner has no objection to the facsimile reproduction by anyone of the patent document or patent disclosure, as it appears in the Patent and Trademark Office patent file or records, but otherwise reserves all copyright rights to this source code.

Using a ubiquitous spreadsheet program as the tool to transfer data, as described above, simplifies the task of transferring data between accounting software applications.

In the explanation below, let the accounting software application, from which data is being taken, be named OLD and the target accounting software application be named NEW. The user opens the spreadsheet. It is noted that the data can be extracted from either desktop software or Online.

To initiate the process, a user activates an extension which launches software development kit (SDK) tools to extract data from OLD accounting software application. Authentication may be required by the OLD accounting software application to obtain permission to extract data.

Then the selected data is read and it is determined what data fields in OLD accounting software application can be successfully imported into NEW accounting software application. For example, if a fax number is in OLD accounting software application but not NEW accounting software application, that data field may be omitted.

The data from OLD accounting software application is reformatted to NEW accounting software application as needed. For example, if zip code in OLD accounting software application is nine digits and zip code in the NEW accounting software application is five digits, the last four digits are removed from OLD accounting software application data. The data is displayed in the correct columns as specified by the NEW accounting software application so the spreadsheet can be imported into NEW accounting software application.

The data is formatted to the NEW accounting software application's specifications. In other words, the user can now sign into NEW accounting software application and follow the instructions for importing a spreadsheet to have all their customers appear in the NEW accounting software application.

The data is formatted to the NEW accounting software application's specifications. In other words, the user can now sign into NEW accounting software application and follow the instructions for importing a spreadsheet to have all their customers appear in the NEW accounting software application.

In another example, let the payroll service, from which the data that is being taken, be named PR and the target online accounting software be named OA.

Payroll service bureaus commonly create files in an IIF or columnar format. These files contain the data representing a journal entry for the payroll expenses for a given pay period. In this example, it is assumed the user has downloaded an IIF file from PR.

The user is instructed to open the IIF file with the spreadsheet.

Upon clicking on an extension in the spreadsheet application associated with IIF format, the data in the spreadsheet is evaluated to make sure it is in IIF format (the user may have modified it by mistake). Error messages will appear if the data does not comply with IIF format.

The data in the spreadsheet is checked for other error conditions. The amount column must sum to zero (debits=credits). Every row having an amount must have an Account. Error messages will appear if these criteria are not satisfied.

The data is written to an XML document that conforms to the OA's journal entry specification.

Using the OA's software development tools, a connection is made to the OA. Authentication may be required by the user.

The XML document is passed to the OA, and the journal entry can be seen by the user when the user logins to the OA.

Source Code 2 extracts transactions and lists from a desktop version of QuickBooks™ or an online version of Quickboks™ writes the transactions and lists in an Excel™ workbook or worksheet.

For example, if a customer wants to stop using a desktop version of QuickBooks™ or an online version of Quickboks™, the customer can utilize Source Code 2, as set forth below, to transfer the data from the desktop version of QuickBooks™ or the online version of Quickboks™ to the new accounting software application.

The following example of source code (Source Code 2) is subject to copyright protection. The copyright owner has no objection to the facsimile reproduction by anyone of the patent document or patent disclosure, as it appears in the Patent and Trademark Office patent file or records, but otherwise reserves all copyright rights to this source code.

Source Code 3 extracts transactions and lists from a desktop version of QuickBooks™ writes the transactions and lists in an Excel™ workbook or worksheet, using Datablox™.

For example, if a customer wants to stop using a desktop version of QuickBooks™, the customer can utilize Source Code 3, as set forth below, to transfer the data from the desktop version of QuickBooks™ to the new accounting software application.

The following example of source code (Source Code 3) is subject to copyright protection. The copyright owner has no objection to the facsimile reproduction by anyone of the patent document or patent disclosure, as it appears in the Patent and Trademark Office patent file or records, but otherwise reserves all copyright rights to this source code.

Source Code 3

Public Sub qbi_GetData( )
‘CH 9/2/14
‘program needs ‘reference’ to OfficeQ6 - but no include file
Dim qbs As officeq6.Reader
Dim nErr
Dim rs As Recordset
Dim a$
a = gini_SetRootDirs( )

‘--- qbs name is arbitrary, but makes code simple to edit
‘--- ole object - dim and create
‘--- OfficeQ6 is the Datablox product

Set qbs = CreateObject(“OfficeQ6.Reader”)

‘--- read the QB company data and create a QQT file

nErr = qbs.ReadFile(“”, “qqtfile=” & gsRootDirData & “QBdata.qqt”)
‘set the data source to be the qqt file
gnDataSource = gnRemoteQQT
‘populate the mdb from the qqt file
nErr = qbi_ImportAllData(gsRootDirData & “QBdata.qqt”, gsRootDirData &
“sprm_prod_2010.mdb”, “”, True)
nErr = qbs.Done( )
qbi_MDBtoExcel

| | |
|---|---|
| Set qbs = Nothing | ‘Note that this line is VERY IMPORTANT |
| | ‘It is what causes the program to disconnect from |
| | ‘the OfficeQ6 module and remove OfficeQ6 from memory |

End Sub
Public Sub qbi_MDBtoExcel( )
‘added by CH
‘data from mdb to excel

| | |
|---|---|
| Dim daoDB | As DAO.Database |
| Dim daoQueryDef | As DAO.QueryDef |
| Dim daoRcd | As DAO.Recordset |

```
Dim lastrow As Long
Dim rowctr As Long
Set daoDB = OpenDatabase(gsRootDirData & “sprm_prod_2010.mdb”)
‘company
Set daoQueryDef = daoDB.QueryDefs(“qCompany”)
Set daoRcd = daoQueryDef.OpenRecordset
Sheets(“Company”).Cells.ClearContents
Sheets(“Company”).Range(“A1”).CopyFromRecordset daoRcd
‘accounts with balances
Set daoQueryDef = daoDB.QueryDefs(“qFiscalYTDTrialBalance”)
Set daoRcd = daoQueryDef.OpenRecordset
Sheets(“Accounts”).Activate
Sheets(“Accounts”).Cells.ClearContents
Sheets(“Accounts”).Range(“A2”).CopyFromRecordset daoRcd
Sheets(“Accounts”).Range(“A1”).Value = “Account #”
Sheets(“Accounts”).Range(“B1”).Value = “Account Name”
Sheets(“Accounts”).Range(“C1”).Value = “Account Type”
Sheets(“Accounts”).Range(“D1”).Value = “Description”
Sheets(“Accounts”).Range(“E1”).Value = “Debit”
Sheets(“Accounts”).Range(“F1”).Value = “Credit”
Sheets(“Accounts”).Columns(“E:G”).Style = “Currency”
Sheets(“Accounts”).Cells.EntireColumn.AutoFit
‘need to translate account types in QB to Kashoo. The TYPE value must be
CAPS and have an underscore to replace a space for Kashoo
    Sheets(“Accounts”).Columns(“C:C”).Replace What:=“FixedAsset”,
Replacement:=“FIXED_ASSET”
    Sheets(“Accounts”).Columns(“C:C”).Replace What:=“AcctRec”,
Replacement:=“ACCOUNTS_RECEIVABLE”
    Sheets(“Accounts”).Columns(“C:C”).Replace What:=“AcctPay”,
Replacement:=“ACCOUNTS_PAYABLE”
    Sheets(“Accounts”).Columns(“C:C”).Replace What:=“OthCurrLiab”,
Replacement:=“OTHER_CURRENT_LIABILITY”
    Sheets(“Accounts”).Columns(“C:C”).Replace What:=“OthCurrAsset”,
Replacement:=“OTHER_CURRENT_ASSET”
    Sheets(“Accounts”).Columns(“C:C”).Replace What:=“COGS”,
Replacement:=“COST_OF_GOODS_SOLD”
    Sheets(“Accounts”).Columns(“C:C”).Replace What:=“CredCard”,
Replacement:=“CREDIT_CARD”
    Sheets(“Accounts”).Columns(“C:C”).Replace What:=“LongTermLiab”,
Replacement:=“LONG_TERM_LIABILITY”
    Sheets(“Accounts”).Columns(“C:C”).Replace What:=“OthAsset”,
Replacement:=“OTHER_ASSET”
    Sheets(“Accounts”).Columns(“C:C”).Replace What:=“OthIncome”,
Replacement:=“INCOME”
    Sheets(“Accounts”).Columns(“C:C”).Replace What:=“OthExpense”,
Replacement:=“EXPENSE”
    Sheets(“Accounts”).Columns(“C:C”).Replace What:=“Loan”,
Replacement:=“LONG_TERM_LIABILITY”
    Sheets(“Accounts”).Columns(“C:C”).Replace What:=“Bank”,
Replacement:=“BANK”
    Sheets(“Accounts”).Columns(“C:C”).Replace What:=“Expense”,
Replacement:=“EXPENSE”
    Sheets(“Accounts”).Columns(“C:C”).Replace What:=“Equity”,
Replacement:=“EQUITY”
    Sheets(“Accounts”).Columns(“C:C”).Replace What:=“Income”,
Replacement:=“INCOME”
‘find Retained Earnings and change its type. Can't change its type to RE cause
Kashoo already has 1 account type RE
‘and does not permit a 2nd account with type RE
‘lastrow = Sheets(“Accounts”).Range(“A” & Rows.Count).End(xlUp).Row
‘For rowctr = 2 To lastrow
```

| | |
|---|---|
| ‘ | If Sheets(“Accounts”).Cells(rowctr, 2).Value = “Retained Earnings” Then |
| ‘ | Sheets(“Accounts”).Cells(rowctr, 3).Value = “RETAINED_EARNINGS” |
| ‘ | End If |

‘Next
‘customers
Sheets(“Customers”).Cells.ClearContents
Set daoQueryDef = daoDB.QueryDefs(“qCustomers”)
Set daoRcd = daoQueryDef.OpenRecordset
Sheets(“Customers”).Range(“A2”).CopyFromRecordset daoRcd
Sheets(“Customers”).Range(“A1”).Value = “Company Name”
Sheets(“Customers”).Range(“B1”).Value = “Email”
Sheets(“Customers”).Range(“C1”).Value = “First Name”
Sheets(“Customers”).Range(“D1”).Value = “Last Name”
Sheets(“Customers”).Range(“E1”).Value = “Street Address”
Sheets(“Customers”).Range(“F1”).Value = “Street Address 2”
Sheets(“Customers”).Range(“G1”).Value = “City”
Sheets(“Customers”).Range(“H1”).Value = “State/Province”
Sheets(“Customers”).Range(“I1”).Value = “Country”
Sheets(“Customers”).Range(“J1”).Value = “Zip/Postal Code”
Sheets(“Customers”).Range(“K1”).Value = “Phone”
Sheets(“Customers”).Range(“L1”).Value = “Fax”
Sheets(“Customers”).Range(“M1”).Value = “Mobile”
Sheets(“Customers”).Range(“N1”).Value = “Toll-free”
Sheets(“Customers”).Range(“O1”).Value = “Ship To Name”
Sheets(“Customers”).Range(“P1”).Value = “Ship To Street”
Sheets(“Customers”).Range(“Q1”).Value = “Ship to Street2”
Sheets(“Customers”).Range(“R1”).Value = “Ship to city”
Sheets(“Customers”).Range(“S1”).Value = “Ship to state or province”
Sheets(“Customers”).Range(“T1”).Value = “Ship to country”
Sheets(“Customers”).Range(“U1”).Value = “Ship to notes”
Sheets(“Customers”).Cells.EntireColumn.AutoFit
‘vendors
Sheets(“Vendors”).Cells.ClearContents
Set daoQueryDef = daoDB.QueryDefs(“qVendors”)
Set daoRcd = daoQueryDef.OpenRecordset
Sheets(“Vendors”).Range(“A2”).CopyFromRecordset daoRcd
Sheets(“Vendors”).Range(“A1”).Value = “Company Name”
Sheets(“Vendors”).Range(“B1”).Value = “Email”
Sheets(“Vendors”).Range(“C1”).Value = “First Name”
Sheets(“Vendors”).Range(“D1”).Value = “Last Name”
Sheets(“Vendors”).Range(“E1”).Value = “Street Address”
Sheets(“Vendors”).Range(“F1”).Value = “Street Address 2”
Sheets(“Vendors”).Range(“G1”).Value = “City”
Sheets(“Vendors”).Range(“H1”).Value = “State/Province”
Sheets(“Vendors”).Range(“I1”).Value = “Country”
Sheets(“Vendors”).Range(“J1”).Value = “Zip/Postal Code”
Sheets(“Vendors”).Range(“K1”).Value = “Phone”
Sheets(“Vendors”).Range(“L1”).Value = “Fax”
Sheets(“Vendors”).Range(“M1”).Value = “Mobile”
Sheets(“Vendors”).Range(“N1”).Value = “Toll-free”
Sheets(“Vendors”).Cells.EntireColumn.AutoFit
‘transactions
Sheets(“Transactions”).Cells.ClearContents
Set daoQueryDef = daoDB.QueryDefs(“qTrans”)
Set daoRcd = daoQueryDef.OpenRecordset
Sheets(“Transactions”).Range(“A1”).CopyFromRecordset daoRcd
Sheets(“Transactions”).Columns(“F:F”).Style = “Currency”
Sheets(“Transactions”).Cells.EntireColumn.AutoFit
Sheets(“Accounts”).Range(“A1”).Select
End Sub
Public Sub callback(control As IRibbonControl)

Select Case control.Tag
Case “fromQB”: qbi_GetData
Case “toPAO”: getaccountids
End Select

End Sub

Source Code 4 transfers transactions and lists in Excel™ to the new accounting application software using the application program interface of the new accounting application software.

For example, if a customer wants to stop using a desktop version of QuickBooks™, the customer can utilize Source Code 4, as set forth below, to transfer the data from Excel™ to the new accounting software application.

The following example of source code (Source Code 4) is subject to copyright protection. The copyright owner has no objection to the facsimile reproduction by anyone of the patent document or patent disclosure, as it appears in the Patent and Trademark Office patent file or records, but otherwise reserves all copyright rights to this source code.

Source Code 4

```
Public Sub connKashoo( )
‘adds an account from the active sheet to Kashoo. Duplicate account names are
not added and return an error.
‘also duplicate account numbers are not added
‘successfully adds accounts to PAO 9/15/14
Dim strToken As String
Dim busID As String
Dim XMLHttp As New MSXML2.XMLHttp
Dim strData As String
Dim aNumber As String
Dim aName As String
Dim aType As String
Dim aDesc As String
Dim xmlAcct As String
Dim xmlAddAcct As String
Dim dt As String
Dim c As String
Dim lastrow As Long
Dim rowctr As Long
Dim wksSheet As Excel.Worksheet
Dim sheetname As String
Application.Cursor = xlWait
sheetname = “Accounts”
Set wksSheet = Application.ActiveSheet
lastrow = Range(“A” & Rows.Count).End(xlUp).Row
Select Case sheetname
Case “Accounts”
dt = Chr(34) & Format(Date, “yyyy-mm-dd”) & Chr(34)
For rowctr = 2 To lastrow
  aNumber = Chr(34) & wksSheet.Cells(rowctr, 1).Value & Chr(34)
  aName = Chr(34) & wksSheet.Cells(rowctr, 2).Value & Chr(34)
  aType = Chr(34) & wksSheet.Cells(rowctr, 3).Value & Chr(34)
  aDesc = Chr(34) & wksSheet.Cells(rowctr, 4).Value & Chr(34)
  xmlAcct = “<account description = “ & aDesc & ” name = “ & aName & ”
number = “ & aNumber & ” openDate = “ & dt & “ type = “ & aType & “/>”
  xmlAddAcct = “<?xml version=“”1.0“” encoding=“”UTF-8“”
standalone=“”yes“”?>” & xmlAcct
  XMLHttp.Open “POST”,
“https://api.paychexaccounting.com/api/businesses/23468118456/accounts”,
False
  XMLHttp.send xmlAddAcct
  strData = strData & XMLHttp.responseText
  xmlAcct = “”
  xmlAddAcct = “”
Next rowctr
Case “Customers”
Case “Vendors”
Case “fiscalyeartotdatetrialbalance”
End Select
‘successsfully gets a token by prompting user for credentials
‘ XMLHttp.Open “POST”, “https://api.kashoo.com/api/authTokens”, False, “”,“”
‘ XMLHttp.send
‘ strToken = XMLHttp.responseText
‘get business ids connected to user. will fail if one or more businesses are
expired
XMLHttp.Open “GET”,
“https://api.paychexaccounting.com/api/users/me/businesses”, False
XMLHttp.setRequestHeader “Authorization”, “AuthSub token=“ & strToken
XMLHttp.send
busID = XMLHttp.responseText
‘successful 9.15.14
‘Dim strData As String
‘XMLHttp.Open “GET”, “https://api.paychexaccounting.com/api/users/me”, False
‘XMLHttp.setRequestHeader “Authorization”, “AuthSub token=” & strToken
‘XMLHttp.send
‘strData = XMLHttp.responseText
Application.Cursor = xlDefault
End Sub
Public Sub postje(id As Double)
‘purpose is to post journal entries to PAO. I was unable to determine the correct
XML form to place multiple
‘journal entries into one XML document. As a result I post and send each journal
entry. This may be OK since I get a
‘response for each journal entry as to its success or failure.
Dim strResp As String
Dim XMLHttp As New MSXML2.XMLHttp
Dim wksSheet As Excel.Worksheet
Dim rowctr As Long
Dim lastrow As Long
Dim trnDate As String
Dim trnNum As Long
Dim trnType As String
Dim trnAmt As String
Dim trnAmount As Long
Dim trnAccount As String
Dim xmlJE As String
Set wksSheet = Application.ActiveSheet
lastrow = Range(“A” & Rows.Count).End(xlUp).Row
‘loop thru all rows in active sheet
For rowctr = 1 To lastrow
  xmlJE = “<?xml version=“”1.0“” encoding=“”UTF-8“” standalone=“”yes“”?>”
  ‘set values for header of journal entry
  trnNum = wksSheet.Cells(rowctr, 1).Value
  trnDate = Chr(34) & Format(wksSheet.Cells(rowctr, 2).Value, “yyyy-mm-dd”) &
Chr(34)
trnType = Chr(34) & wksSheet.Cells(rowctr, 3).Value & Chr(34)
xmlJE = xmlJE & “<manualAdjustmentRecord memo=“”QuickBooks import”
currency=“USD” date= “ & trnDate & ” number = “ & trnType &
”><adjustments>”
    ‘loop thru each row having same transaction ID. These rows create the
journal entry.
    Do While trnNum = wksSheet.Cells(rowctr, 1).Value
      trnAccount = Chr(34) & wksSheet.Cells(rowctr, 7).Value & Chr(34)
      trnAmount = Str$(−100 *wksSheet.Cells(rowctr, 6).Value)
      trnAmt = Chr(34) & trnAmount & Chr(34)
      xmlJE = xmlJE & “<adjustment account= “ & trnAccount & ” amount = “ &
trnAmt & ” currency=“”USD“”/>”
      rowctr = rowctr + 1
    Loop
    xmlJE = xmlJE & “</adjustments></manualAdjustmentRecord>”
    rowctr = rowctr − 1
    XMLHttp.Open “POST”,
“https://api.paychexaccounting.com/api/businesses/” & id &
“/records/adjustments”, False
    XMLHttp.send xmlJE
    strResp = strResp & XMLHttp.responseText
    xmlJE = “”
Next rowctr
End Sub
```

In summary, a method and system automatically convert formatted data from one software application source into a format compatible for importing into another software application, using a third software application by launching, through a user's interaction with a user interface associated with the computer, a spreadsheet application; launching, through a user's interaction with a user interface associated with the computer, a first accounting software application; initiating, through a user's interaction with the user interface associated with the computer, a first extension of the launched spreadsheet application; electronically connecting the initiated first extension with the launched first accounting software application, through an application program interface of the launched first accounting software application, to create a first electronic data channel between the initiated first extension and the launched first accounting software application; electronically pulling, by the initiated first extension, accounting data from the launched first accounting software application through the first electronic data channel to the initiated first extension; electronically converting, by the initiated first extension, the pulled data into a format compatible with a second accounting software application; electronically writing, by the initiated first extension, the converted data into a workbook created by the launched spreadsheet application; launching, through a user's interaction with the user interface associated with the computer, a second accounting software application; initiating, through a user's interaction with the user interface associated with the computer, a second extension of the launched spreadsheet application; electronically connecting the initiated second extension with the launched second accounting software application, through an application program interface of the launched second accounting software application to create a second electronic data channel between the initiated second extension and the launched second accounting software application; electronically converting, by the initiated second extension, the converted data in the workbook to a format compatible for importing into the launched second accounting software application; and electronically pushing the format compatible data into the launched second accounting software application.

The electronic conversion by the initiated second extension may convert the converted data in the workbook to a XML format. The electronic conversion by the initiated first extension may convert the pulled data by using pre-determined tables which map data fields of the launched first accounting software application to data fields of the launched second accounting software application. The converted data in the workbook may be edited by a user before the second extension of the launched spreadsheet application is initiated through a user's interaction with the user interface associated with the computer.

The launched spreadsheet application may reside on the computer and the accounting data from the launched first accounting software application may reside on the computer.

The launched spreadsheet application may reside on the computer and the accounting data from the launched first accounting software application may reside on a second computer communicatively connected to the computer through a local area network.

The launched spreadsheet application may reside on the computer and the accounting data from the launched first accounting software application may reside on a second computer communicatively connected to the computer through a wide area network.

The launched spreadsheet application may reside on the computer and the accounting data for the launched second accounting software application may reside on the computer.

The launched spreadsheet application may reside on the computer and the accounting data for the launched second accounting software application may reside on a second computer communicatively connected to the computer through a local area network.

The launched spreadsheet application may reside on the computer and the accounting data for the launched second accounting software application may reside on a second computer communicatively connected to the computer through a wide area network.

It is noted that the various embodiments may be carried out by a processor executing software corresponding to the source code described herein or the various embodiments may be carried out by firmware executing processes corresponding to the source code described herein.

It is further noted that processes described herein may be carried out in a single computer, over a local area network, or over a wide area network (internet or cloud).

To enable payroll service companies to setup new customers quickly and accurately, the process begins by obtaining a portable document file (pdf) report from the competitor payroll company. This report contains most of the necessary data to setup a new customer.

The pdf report is converted to a spreadsheet using conventional software. The language native to the spreadsheet is used to parse and reformat the data in the spreadsheet into a format which can be imported to the new payroll service company.

This process can save a large payroll company thousands of data entry hours.

For example, the process obtains a pdf report from a competitor payroll service company.

After obtaining the pdf, conventional software is used to convert the pdf to a spreadsheet file.

Although the data has been put into a spreadsheet file, the data in the spreadsheet file may not be in a form that can be readily imported into the new payroll service company's application software.

More specifically, initially all the data may be looped through, and the rows that do not have relevant information; e.g., page headers and footers, totals at end of report, rows where an employee is continued on next page; are deleted.

An example of this process is provided as source code in Table 1 below.

```
TABLE 1
‘delete empty rows and rows having no relevant data
For emptyrow = lastrow To 1 Step (−1)
  str = Cells(emptyrow, 1).Value & Cells(emptyrow, 2).Value & Cells(emptyrow,
3).Value & Cells(emptyrow, 4).Value & Cells(emptyrow, 5).Value
  Select Case True
  Case str = “”, (str Like “*Master*Control*”), (str Like “*matic*Data*”), (str Like
“*Period*Ending*”)
    Rows(emptyrow).Select
    Selection.ClearContents
    Selection.Delete Shift:=xlUp
  End Select
Next
```

Thereafter, it is determined what data identifies the first row for each new employee; e.g., row must contain one comma and be followed by a row with “File.”

An example of this process is provided as source code in Table 2 below.

```
TABLE 2
‘determine if a row contains an employee name by the presence of a comma
followed by the word File
If InStr(s.Cells(g, 1).Value, “,”) > 0 Then
  If Left(LTrim(s.Cells(g + 1, 1).Value), 4) = “File”_
  Or Left(LTrim(s.Cells(g + 2, 1).Value), 4) = “File”_
  Or Left(LTrim(s.Cells(g + 3, 1).Value), 4) = “File”_
  Or Left(LTrim(s.Cells(g + 4, 1).Value), 4) = “File”_
  Or Left(LTrim(s.Cells(g + 5, 1).Value), 4) = “File”_
  Or Left(LTrim(s.Cells(g + 6, 1).Value), 4) = “File” Then
    eerow = True
  Else
    eerow = False
  End If
End If
```

The first row number of an employee in a variable (var1) and the last row number of same employee in a variable (var2) are stored.

Column A from var1 to var2 is looped through, and the data in each cell is evaluated. The data is written to a new sheet in the spreadsheet in the exact format and column required by the target payroll system.

For example, copy first name into column A of new sheet, middle initial to column B of new sheet, and last name to column C of new sheet.

An example of this process is provided as source code in Table 3 below.

```
TABLE 3
For wkctr = wkfirstrownum To wklastrownum
‘row with name has a comma
  ‘If commapos > 0 And Not csz(wks.Cells(wkctr, 1)) Then
  If wkctr = wkfirstrownum Then
      Sheets(“AllEmps”).Cells(filerowctr, 3).Value = “EE”
```

| | | |
|---|---|---|
| Sheets(“AllEmps”).Cells(filerowctr, | 4).Value | = |

WorksheetFunction.Proper(Mid(wks.Cells(wkctr, 1), commapos + 1))

| | | |
|---|---|---|
| Sheets(“AllEmps”).Cells(filerowctr, | 6).Value | = |

```
WorksheetFunction.Proper(Mid(wks.Cells(wkctr, 1), 1, commapos − 1))
      ‘if middle initial exists then copy into col 5 and strip it off col 4
      If middleinitial(Mid(wks.Cells(wkctr, 1), commapos + 1)) > 0 Then
        Sheets(“AllEmps”).Cells(filerowctr, 5).Value = Mid(Mid(wks.Cells(wkctr,
1), commapos + 1), middleinitial(Mid(wks.Cells(wkctr, 1), commapos + 1)), 1)
```

| Sheets(“AllEmps”).Cells(filerowctr, | 4).Value | | | = |
|---|---|---|---|---|
| WorksheetFunction.Proper(Left(Mid(wks.Cells(wkctr, | 1), | commapos | + | 1), |

```
    Len(Mid(wks.Cells(wkctr, 1), commapos + 1)) − 2))
      End If
      ‘if no gross wages then change font to red bold
      If InStr(wks.Cells(wkctr, 5), “Gross”) = 0 Then
        Sheets(“AllEmps”).Cells(filerowctr, 2).Font.Color = 255
        Sheets(“AllEmps”).Cells(filerowctr, 2).Font.FontStyle = “Bold”
      End If
  End If
    ‘first row following employee name is first line of address
  If wkctr = wkfirstrownum + 1 Then
```

| | | |
|---|---|---|
| Sheets(“AllEmps”).Cells(filerowctr, | 14).Value | = |

WorksheetFunction.Proper(wks.Cells(wkctr, 1))
End If

It is noted that formatting may be critical. For example, the formatting may require that the leading zero on file number is dropped, the leading zero on zip code is retained, the hyphens from social security number are removed, or the date must be in the mm/dd/yyyy format.

Any unexpected data like a non-U.S. address or an amount such as $1.55 which is displayed without the decimal as $1 55 is addressed.

For the same employee, from rows var1 to var2, the process loops through column B and repeat the steps described above.

The looping is repeated for every column in the spreadsheet file, which has data.

The process described above is repeated for the next employee, and is repeated for every employee in the spreadsheet file.

It is noted that banking data for employee direct deposit of paychecks must be interpreted and reformatted.

For example, one employee has $100 of their paycheck deposited to a savings account and the remainder of their paycheck deposited to their checking account. Payroll systems do not represent this event in the same way. The information in the source system must be understood and modified to fit the target system.

An example of this process is provided as source code in Table 4 below.

```
TABLE 4
If wks.Cells(rowctrD + 1, 4).Value Like “*Partial*” Then
  foundpartialamt = False
    ‘define the ADP code used for this direct deposit
```

| | | | |
|---|---|---|---|
| partiaIDDcode | = | LTrim(Mid(wks.Cells(rowctrD, | 4), |

```
InStr(wks.Cells(rowctrD, 4), “Code”) + 4))
      ‘look for the partial DD amount related to the partial DD code by
working backward in column D
      For b = rowctrD To wkfirstrownum Step (−1)
        ‘the partial DD code followed by a space and SAV, or just an X
followed by unrelated text, to assure it is the direct deposit code and to identify it
as savings
        If wks.Cells(b, 4).Value Like “*” & “ ” & partiaIDDcode & ” *S*V*”
Or partiaIDDcode = “X ” Then
          Sheets(“DirDep”).Cells(DDfilerowctr, 5).Value = “S”
          Sheets(“DirDep”).Cells(DDfilerowctr, 6).Value = “A”
```

| | | |
|---|---|---|
| Sheets(“DirDep”).Cells(DDfilerowctr, | 7).Value | = |

```
partiaIDDamt(Left(wks.Cells(b, 4), InStr(wks.Cells(b, 4), “ ” & partiaIDDcode & ”
”)))
          foundpartialamt = True
        End If
        ‘however if the string ends in _X with no identifier following it, and
the code is X, assume it is checking and omit trailing space when calling
partiaIDDamt
        If wks.Cells(b, 4).Value Like “*## X” And partiaIDDcode = “X”
Then
          Sheets(“DirDep”).Cells(DDfilerowctr, 5).Value = “S”
          Sheets(“DirDep”).Cells(DDfilerowctr, 6).Value = “A”
```

| | | |
|---|---|---|
| Sheets(“DirDep”).Cells(DDfilerowctr, | 7).Value | = |

```
partiaIDDamt(Left(wks.Cells(b, 4), InStr(wks.Cells(b, 4), “ ” & partiaIDDcode)))
          foundpartialamt = True
        End If
        ‘the partial DD code followed by a space and CH or CK, or just a Y
followed by unrelated text, to assure it is the direct deposit code and to identify it
as checking
        If wks.Cells(b, 4).Value Like “*” & “ ” & partiaIDDcode & “*CH*” Or
wks.Cells(b, 4).Value Like “*” & “ ” & partiaIDDcode & “*CK*” Or partiaIDDcode =
“ Y ” Then
          Sheets(“DirDep”).Cells(DDfilerowctr, 5).Value = “C”
          Sheets(“DirDep”).Cells(DDfilerowctr, 6).Value = “A”
```

| | | |
|---|---|---|
| Sheets(“DirDep”).Cells(DDfilerowctr, | 7).Value | = |

```
partiaIDDamt(Left(wks.Cells(b, 4), InStr(wks.Cells(b, 4), “ ” & partiaIDDcode & ”
”)))
          foundpartialamt = True
        End If
        ‘however if the string ends in _Y with no identifier following it, and
the code is Y, assume it is savings and omit trailing space when calling
partiaIDDamt
        If wks.Cells(b, 4).Value Like “*## Y” And partiaIDDcode = “Y”
Then
          Sheets(“DirDep”).Cells(DDfilerowctr, 5).Value = “C”
          Sheets(“DirDep”).Cells(DDfilerowctr, 6).Value = “A”
```

| | | |
|---|---|---|
| Sheets(“DirDep”).Cells(DDfilerowctr, | 7).Value | = |

```
partiaIDDamt(Left(wks.Cells(b, 4), InStr(wks.Cells(b, 4), “ ” & partiaIDDcode)))
          foundpartialamt = True
        End If
    Next
      ‘if the partial DD amount was never found that means there is a bank
acct for partial DD but no matching amt. Write a DD row with $0 amount
      If Not foundpartialamt Then
        Sheets(“DirDep”).Cells(DDfilerowctr, 5).Value = “C”
        Sheets(“DirDep”).Cells(DDfilerowctr, 6).Value = “A”
        Sheets(“DirDep”).Cells(DDfilerowctr, 7).Value = “0.00”
      End If
End If
```

The same is true for employee tax information. The state filing status code may be MFS (married filing separate) in the source system and MWS (married withhold as single) in another system. This must be understood and translated for all 50 states.

An example of this process is provided as source code in Table 5 below.

```
TABLE 5
‘states with no income tax and several other states must have blank filing status.
Also translation of filing status codes.
  Select Case Sheets(“AllEmps”).Cells(filerowctr, 60).Value
    Case “AK”, “AR”, “AZ”, “FL”, “IL”, “IN”, “KY”, “MI”, “MT”, “NH”, “NV”,
“OH”, “PA”, “SD”, “TN”, “TX”, “VA”, “WA”, “WY”
    Sheets(“AllEmps”).Cells(filerowctr, 62).Value = “”
    Case “NJ”
```

| | | |
|---|---|---|
| Sheets(“AllEmps”).Cells(filerowctr, | 62).Value | = |

Replace(Sheets(“AllEmps”).Cells(filerowctr, 62).Value, “S”, “A”)

| | | |
|---|---|---|
| Sheets(“AllEmps”).Cells(filerowctr, | 62).Value | = |

Replace(Sheets(“AllEmps”).Cells(filerowctr, 62).Value, “M”, “SMCU”)
Case “CA”

| | | |
|---|---|---|
| Sheets(“AllEmps”).Cells(filerowctr, | 62).Value | = |

Replace(Sheets(“AllEmps”).Cells(filerowctr, 62).Value, “M”, “MI1”)
Case “DE”, “DC”

| | | |
|---|---|---|
| Sheets(“AllEmps”).Cells(filerowctr, | 62).Value | = |

Replace(Sheets(“AllEmps”).Cells(filerowctr, 62).Value, “M”, “J”)
Case “GA”

| | | |
|---|---|---|
| Sheets(“AllEmps”).Cells(filerowctr, | 62).Value | = |

Replace(Sheets(“AllEmps”).Cells(filerowctr, 62).Value, “M”, “JW”)
Case “MD”

| | | |
|---|---|---|
| Sheets(“AllEmps”).Cells(filerowctr, | 62).Value | = |

Replace(Sheets(“AllEmps”).Cells(filerowctr, 62).Value, “M”, “MSSH”)
Case “WV”

| | | |
|---|---|---|
| Sheets(“AllEmps”).Cells(filerowctr, | 62).Value | = |

Replace(Sheets(“AllEmps”).Cells(filerowctr, 62).Value, “M”, “2E”)

| | | |
|---|---|---|
| Sheets(“AllEmps”).Cells(filerowctr, | 62).Value | = |

Replace(Sheets(“AllEmps”).Cells(filerowctr, 62).Value, “S”, “R”)
Case “AL”, “MA”, “MS”, “MO”

| | | |
|---|---|---|
| Sheets(“AllEmps”).Cells(filerowctr, | 62).Value | = |

Replace(Sheets(“AllEmps”).Cells(filerowctr, 62).Value, “M”, “H”)
End Select

Also, an employee may have a child support deduction of $50 per paycheck with a total amount due of $2,000 which must be deducted before any other voluntary payroll deduction. The data to describe this deduction must be understood and translated.

In the process, as each employee's data is evaluated, the data is written into new worksheets according to the specifications of the target payroll system. For example, employee demographics on sheet1, banking data on sheet2, payroll deductions on sheet3, year-to-date wage information on sheet4.

After the data is written into the spreadsheet file, the data for each sheet is converted to a csv file and then imported into the target payroll system.

In another example, a service company in an industry such as payroll or accounting is constantly trying to maintain and grow its customer base. Each customer represents a recurring revenue stream and it is costly when the company loses its customers. It is also costly to acquire new customers. Any method to lower the customer acquisition cost (CAC) without sacrificing value to the customer is very important.

CAC include sales and marketing to acquire the customer. CAC also include the cost of moving the customer's information from the previous service (hereafter the prior company) to the new service (hereafter the new company). This invention discusses a method of automating the transfer of data necessary when onboarding new customer data. It is a generic solution in that it applies to many service industries with little or no modification to the process.

As one would expect, the prior payroll company does not wish to lose its customers and will make it difficult for a customer to move their data to a new payroll company. The prior payroll company may do this by limiting data export features in its software. It could prevent the export of critical data. If the prior payroll company learns their customer is “shopping around” it may make price concessions to retain the customer. This means the speed of moving customer data is important to the new payroll company. The faster it can be done, the less time for the prior payroll company to react.

While data export features may be limited in the software, it is impractical to limit the reports a customer can get. A large part of the value of the service is in the reports. Since virtually every payroll company provides reports in an Adobe™ PDF (portable document format) form, the ideal solution for the new payroll company is to obtain the necessary data from PDF reports. It may be necessary to obtain several PDF reports to collect all the necessary data. Therefore, it is important to have the ability to easily modify the process for each new type of report.

The process begins with the new payroll company offering a web site where the customer will upload their PDF reports from the prior payroll company. The user is instructed to upload report A, B, or C at the corresponding links. A sample of each report, enabling the user to confirm that the correct report has been uploaded, is available by clicking on the icon at the left of each button. This is important since many reports look similar, or have similar names, but have significant differences in data.

Upon successful uploading, each report is stored in its own folder on a server. Each folder is named by the prior payroll company and report type. A computer program monitors these folders 24×7. As soon as a new file is found, the program launches conventional commercially available software to convert the uploaded PDF to a csv file. This is completed with no manual intervention.

The conventional commercially available software provides the payroll company with the ability to open a PDF and draw vertical lines to indicate how the data will be parsed into columns. The combination of these vertical lines in specific positions is saved in a template.

Each report type, from each prior payroll company, will have its own template created in advance. The PDF conversion software uses the saved template to assure the data always appears in the exact same column. Across an unlimited number of the same type of report, the resulting csv file will have the data in the same positions.

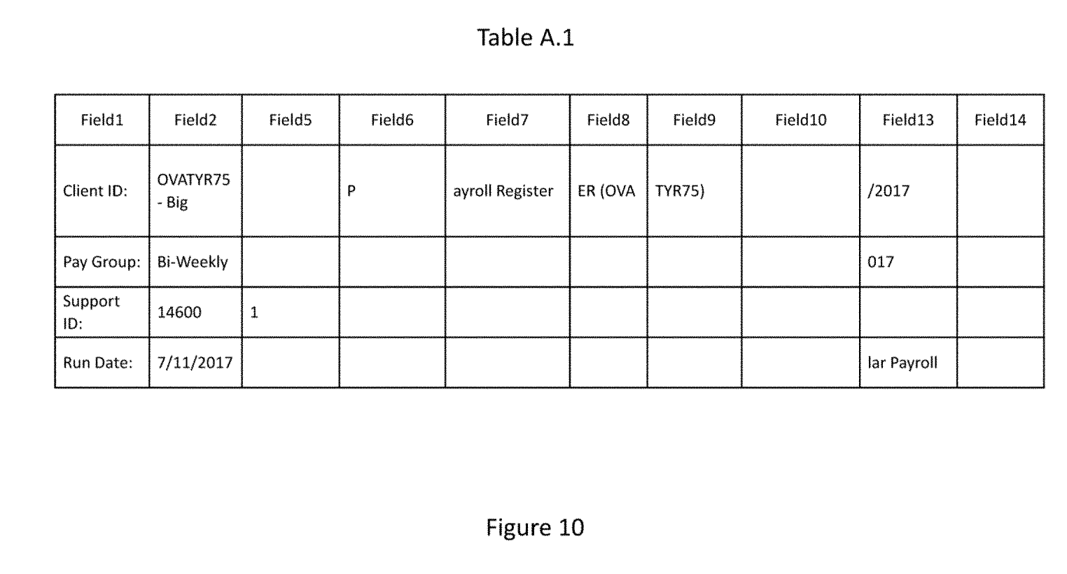

FIG. 10 illustrates a first portion of Table A (Table A.1). Table A, in its entirety (FIGS. 10 through 13), shows a common payroll register report that originated in PDF, was converted to csv as described above, and imported into a database. The report had 14 columns (4 columns are hidden and unnecessary for this example).

As illustrated in FIG. 10, the first portion of Table A (Table A.1) shows the header information of the payroll register report.

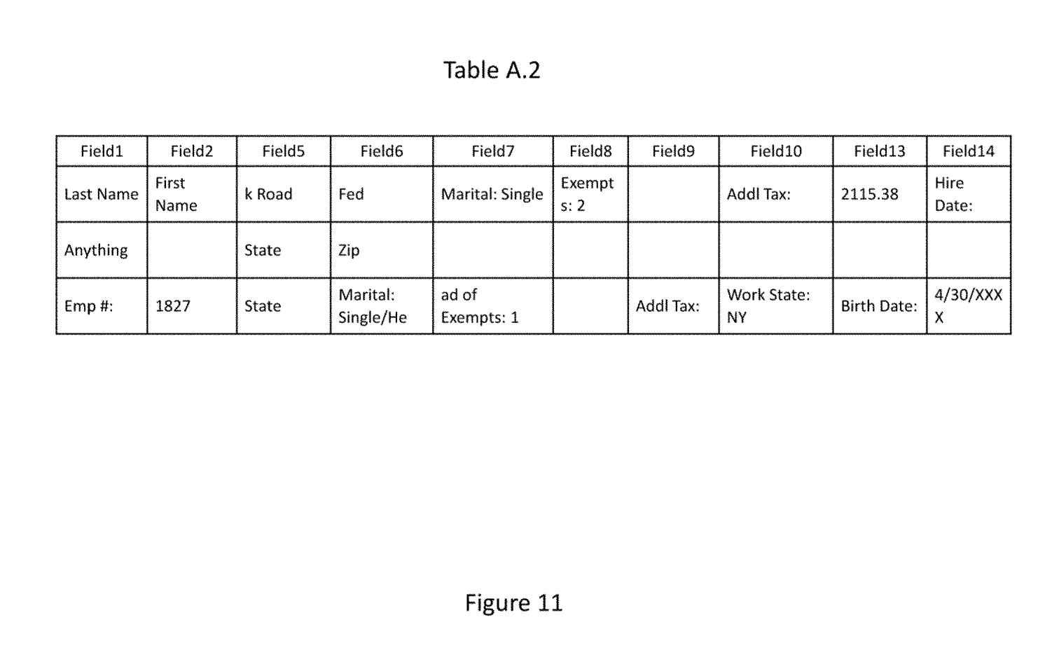

FIG. 11 illustrates a second portion of Table A (Table A.2). As illustrated in FIG. 11, the second portion of Table A (Table A.2) shows the payroll information for employee number 1827.

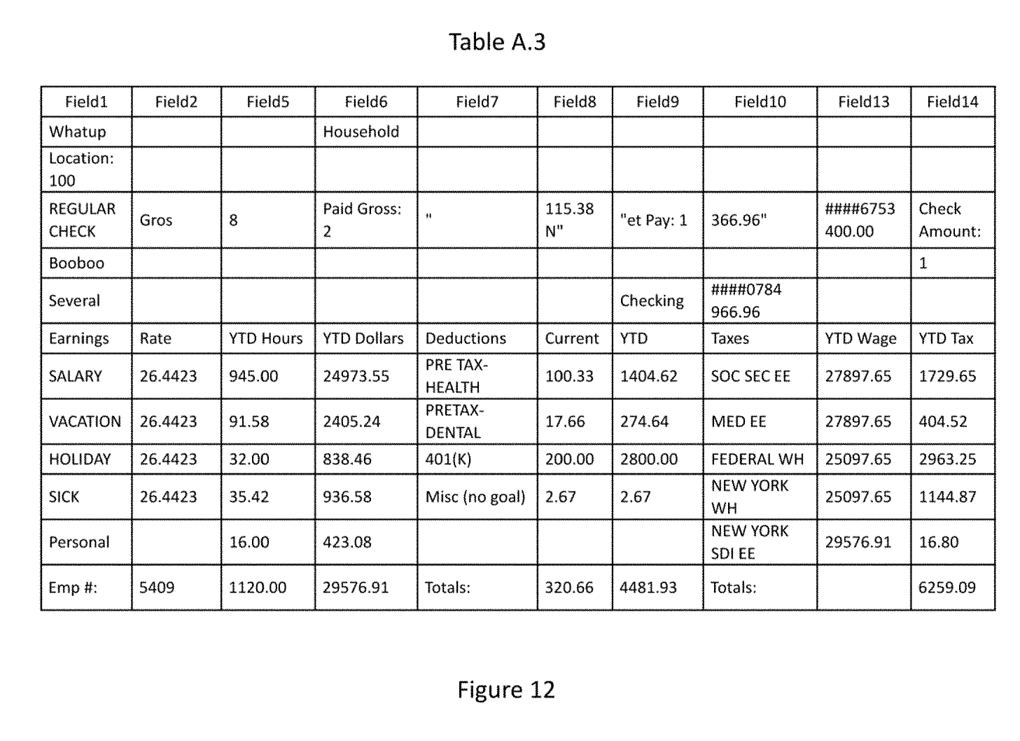

FIG. 12 illustrates a third portion of Table A (Table A.3). As illustrated in FIG. 12, the second portion of Table A (Table A.3) shows the payroll information for employee number 5409.

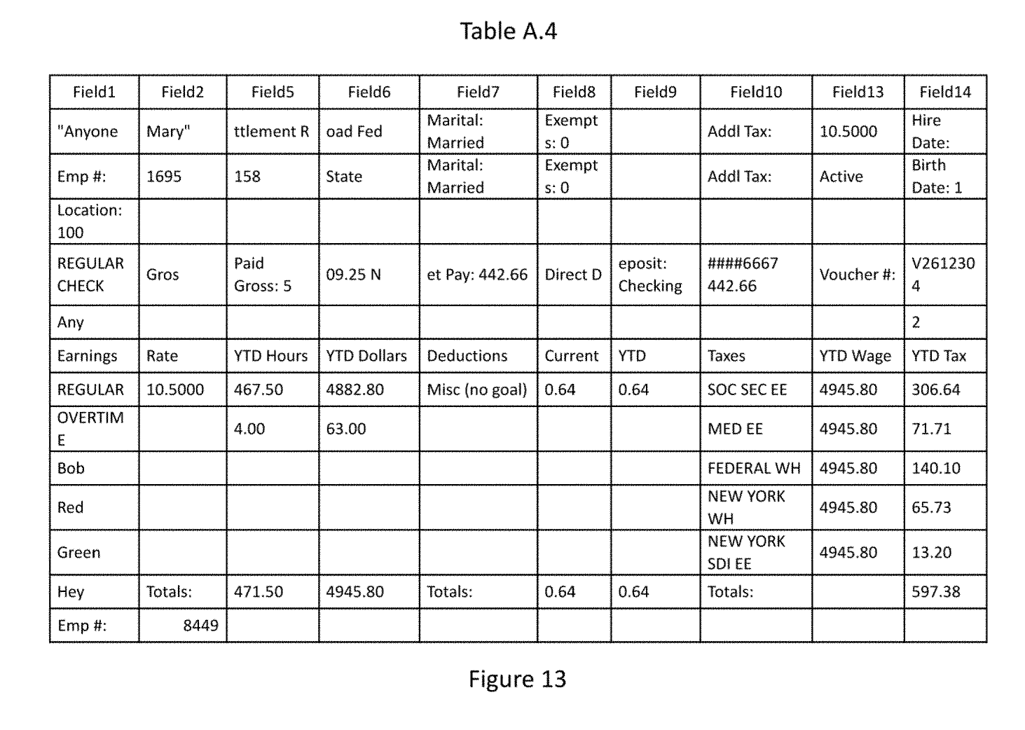

FIG. 13 illustrates a fourth portion of Table A (Table A.4). As illustrated in FIG. 13, the second portion of Table A (Table A.4) shows the payroll information for employee numbers 1695 and 8449.

As illustrated in FIG. 10, in the first row, the word “Payroll” is split between columns (fields) 6 and 7. Also, a date in column (field) 13 has been truncated. These conditions would seem to make it unreadable.

However, the vertical lines are drawn to isolate only the data required for extraction. For example, as illustrated in FIG. 12, the column titled “Field5” shows exactly the YTD Hours value that is desired for output. The template is created precisely for the data of interest to be confined to a single column. The concept of “labels” is used in this process.

The first employee's data begins, as illustrated in the example of FIG. 11, where “Emp #:” is displayed in a column and the employee number is 1827. The employee # is a key data point that is extracted.

If “Emp #:” was not displayed, it would be problematic to know that 1827 is the employee number The text “Emp #:” is called a label in this context.

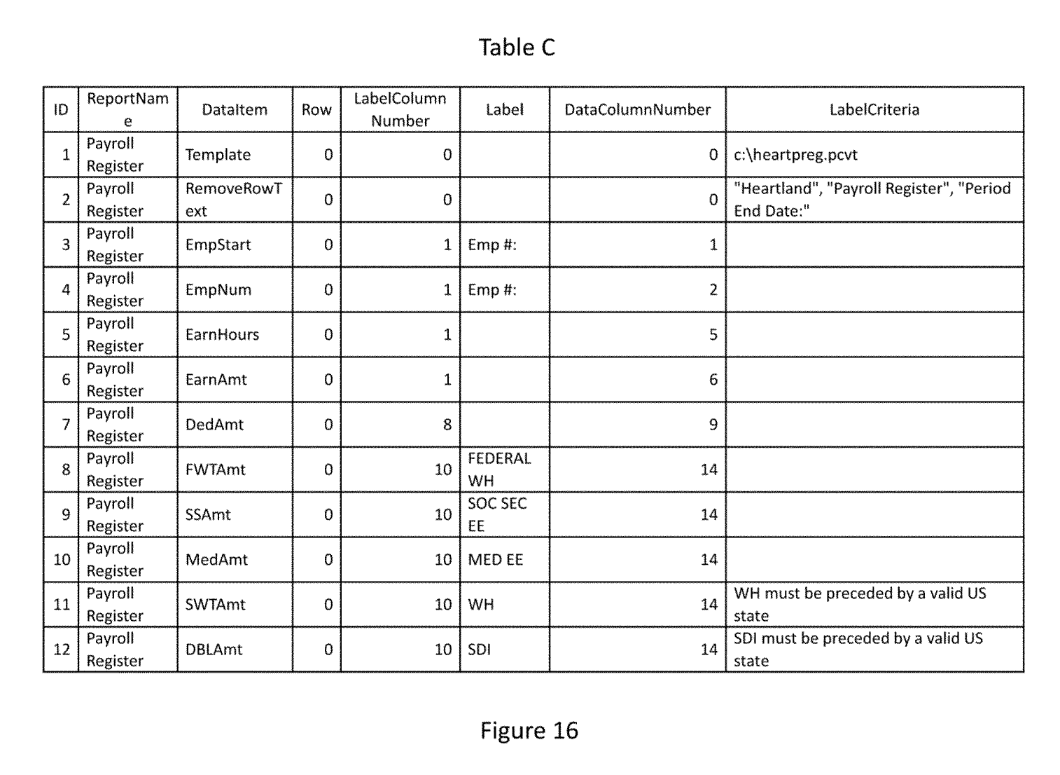

To locate the employee number, the definition of the label is derived (in this case “Emp #:), what column (field) the label is determined (column (field) 1 in Table A), and what column the actual employee number is stored in (column (field) 2 in Table A). This information is stored in the database as shown in FIG. 16.

The label's definition may be derived by comparing a comma separated value with a table of values of known labels. For example, for the label, employee number, the table of values may include “Employee Number,” “Employee #,” “Employee Num,” “Emp Num,” or “Emp #,” as possible representations for the label. In this example, if the conversion process encounters a comma separated value having the value, Employee Num, the conversion process would identify the comma separated value as being a label for the employee number.

Another example is federal income tax withheld. As illustrated in the example of FIG. 12, the label for federal income tax withheld is “FEDERAL WH.” This label, as illustrated in the example of FIG. 12, is found in column (field) 10, and the actual value in column (field) 14.

As discussed above, the label's definition may be derived by comparing a comma separated value with a table of values of known labels. For example, for the label, federal income tax withheld, the table of values may include “Fed WH,” “Federal Withheld,” “Fed Inc Tax,” “Federal Income Tax,” or “Fed Tax,” as possible representations for the label. In this example, if the conversion process encounters a comma separated value having the value, Federal Withheld, the conversion process would identify the comma separated value as being a label for the federal income tax withheld.

Upon identifying the label and its location, the conversion process can determine the associated data. In the example of FIG. 12, the associated data is 2963.25.

The associated data may be identified by analyzing comma separated values in the same row as the identified label, but in a different column that is located to the right of the label's location.

For example, as illustrated in FIG. 12, the associated data (2963.25) is located in the same row but in a different column that is located to the right of the label's location.

The data (25097.65) is not associated with label for federal income tax withheld because the label YTD Wage being located in the same column as the data (25097.65).

The data (2963.25) is associated with label for federal income tax withheld because the label YTD Tax being located in the same column as the data (2963.25).

In other words, in this example, the associated data was determined based upon the intersection of the location of two corresponding labels, FEDERAL WH and YTD Tax.

The implication is that the relevant data from any report, given the precise template to create columns and the information as described above, can be accurately extracted. For each new report, it is only necessary to modify the template and above information.

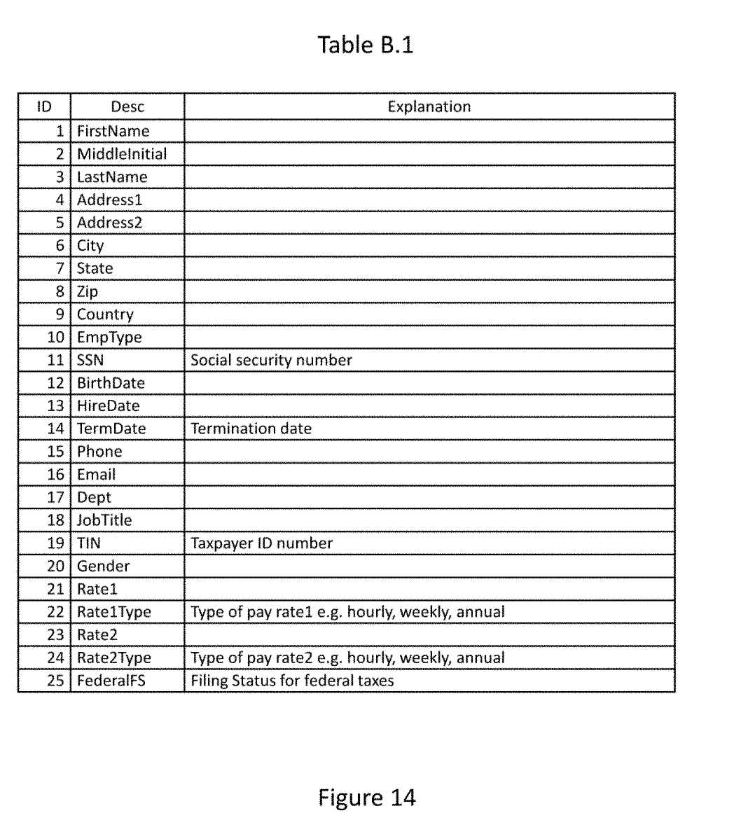

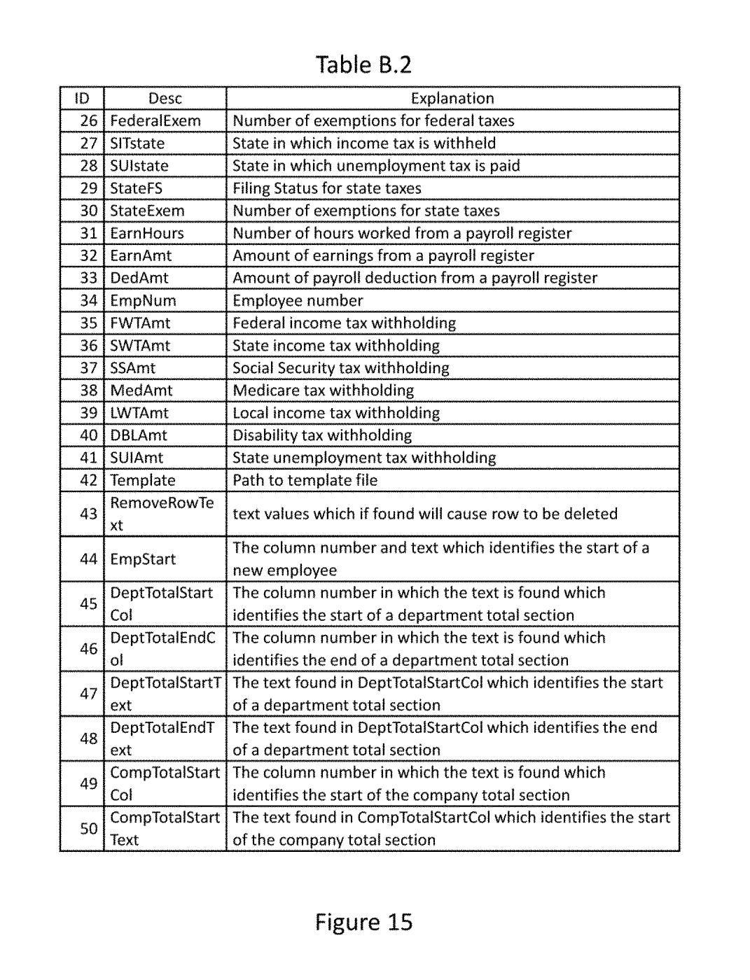

FIG. 14 illustrates a first portion of Table B (Table B.1), and FIG. 15 illustrates a second portion of Table B (Table B.2). Table B, in its entirety (FIGS. 14 and 15), illustrates examples of relevant data items for the payroll industry.

It is noted that the above described conversion process may be extended to any industry, e.g. accounting or tax reports.

FIG. 16 illustrates Table C. Table C is an example of storing, in a database, the specific labels and column numbers for the report, as shown in FIG. 10 through FIG. 13.

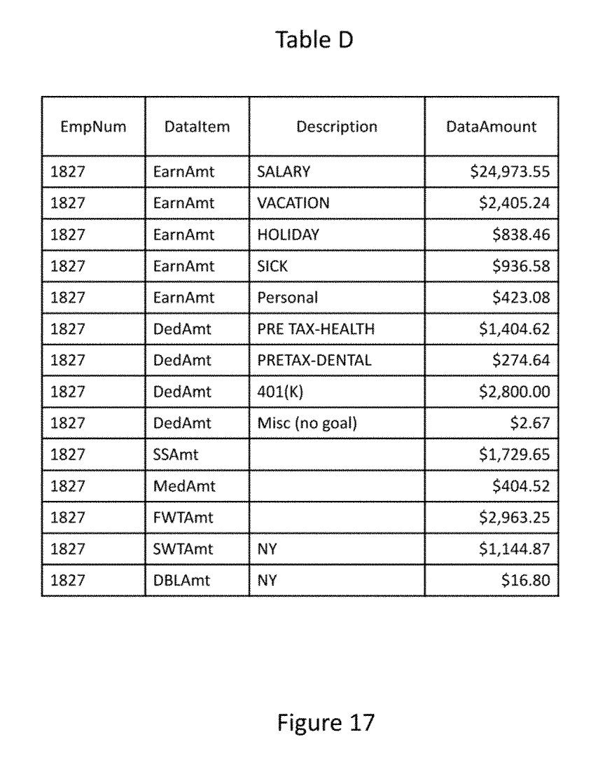

Below is an example of java source code, which uses the values in Table C of FIG. 16, to convert a payroll register report for Heartland Company to generate the payroll data, as shown in Table D of FIG. 17.

```
import java.sql.*;
import java.util.Properties;
public class pyd1
{
  public static void main(String[ ] args)
  {
  String connectionUrl= “jdbc:easysoft:mdb” +
“?DBQ=C:/Users/Hurlbut/java/PYD.accdb”;
  Driver driver = null;
  Connection con = null;
    try {
      Class.forName(“easysoft.sql.esMdbDriver”);
      driver = DriverManagergetDriver(connectionUrl);
      con = DriverManagergetConnection(connectionUrl);
      Statement s = con.createStatement( );
      // Find record in tReport that identifies the text and column # that denote a
new employee for this specific report.
      // Using 3 string values as conditions in WHERE gave Function sequence
error. Assumed bug.
      String compChoice = “Heartland”;
      ResultSet rs = s.executeQuery(“SELECT * FROM tReport WHERE
ReportName=‘Payroll Register’ AND Item=‘EmpStart’”);
      String eStartText;
      int eStartCol;
      rs.next( );
      eStartText = rs.getString(“Label”);
      eStartCol = rs.getInt(“LabelColumnNumber”);
      //  following for debugging
      //  System.out.println(eStartCol + “\n”);
      //  System.out.println(eStartText + “\n”);
      rs.close( );
      // Find record in tReport that identifies the label and its column that denotes
the employee number.
      rs = s.executeQuery(“SELECT * FROM tReport WHERE
ReportName=‘Payroll Register’ AND Item=‘EmpNum’”);
      String enumLabel;
      int enumLabelCol;
      int enumCol;
      rs.next( );
      enumLabel = rs.getString(“Label”);
      enumLabelCol = rs.getInt(“LabelColumnNumber”);
      enumCol = rs.getInt(“DataColumnNumber”);
      //  following for debugging
      //  System.out.println(enumLabel + “\n”);
      //  System.out.println(enumLabelCol + “\n”);
      //  System.out.println(enumCol + “\n”);
      rs.close( );
      // loop through the table named tlnput having contents of report
      rs = s.executeQuery(“SELECT * FROM tInput”);
          String eNum = “”;
          // loop through all rows of report
          while (rs.next( )) {
            String fld = rs.getString(“Field1”);
            // find first record having eStartText. In other words where the first
employee begins.
            if (fld.contains(eStartText)) {
              do {
                // get employee number
                eNum = rs.getString(“Field2”);
                System.out.println(eNum + “\n”);
                  // get earnings amount if a numeric value exists
                  if (rs.getString(“Field5”) != null) {
                    String eEarnings = rs.getString(“Field5”);
                  }
                //move to next row
                rs.next( );
                // do this until a new employee is reached
              }while(!rs.getString(“Field1”).contains(eStartText));
            }
          }
      rs.close( );
      // add values to output table
      String addRow = “INSERT INTO tOutput ” + “VALUES(“ + eNum + ”, ‘B’,
eEarnings)”;
      s.executeUpdate(addRow);
    // close and cleanup
        s.close( );
        con.close( );
        }
      catch(Exception ex)
      {
          ex.printStackTrace( );
      }
  }
}
```

FIG. 17 shows the output formatted in a typical format for import into a payroll system.

A method automatically converts data printed on a physical document into an electronic format compatible for importing into a database by: (a) optically scanning, using a scanner, the physical document having data printed thereon to create an electronic portable document format file of image data; (b) electronically creating, using a user input interface, within the electronic portable document format file of image data, parsing demarcations; (c) converting, using a computer operatively connected to the scanner, the portable document format file of image data into an electronic comma separated values file of ASCII characters, based upon the created demarcations, using an optical character recognition process, the created parsing demarcations being used to locate commas in the created electronic comma separated values file of ASCII characters; (d) electronically identifying, in the created electronic comma separated values file of ASCII characters, labels; (e) electronically identifying, in the created electronic comma separated values file of ASCII characters, data corresponding to each identified labels; (f) electronically associating the identified data with the corresponding identified label; and (g) electronically pushing the associated identified data with the corresponding identified label into a database.

The electronic creating of parsing demarcations may be realized by a user electronically drawing vertical lines in the electronic portable document format file of image data.

The electronic identifying of labels may be realized by comparing a comma separated value with a table of values corresponding to labels.

The electronic identifying of data corresponding to each identified labels may be realized by identifying a non-label comma separated value located in a same row of an identified label comma separated value but a different column of the identified label comma separated value.

The electronic identifying of data corresponding to each identified labels may be realized by identifying a non-label comma separated value located in a different row of an identified label comma separated value but a same column of the identified label comma separated value.

A method automatically converts an electronic portable document format file of image data into an electronic format compatible for importing into a database by: (a) receiving an electronic portable document format file of image data; (b) electronically creating, using a user input interface, within the electronic portable document format file of image data, parsing demarcations; (c) converting, using a computer, portable document format file of image data into an electronic comma separated values file of ASCII characters, based upon the created demarcations, using an optical character recognition process, the created parsing demarcations being used to locate commas in the created electronic comma separated values file of ASCII characters; (d) electronically identifying, in the created electronic comma separated values file of ASCII characters, labels; (e) electronically identifying, in the created electronic comma separated values file of ASCII characters, data corresponding to each identified labels; (f) electronically associating the identified data with the corresponding identified label; and (g) electronically pushing the associated identified data with the corresponding identified label into a database.

The electronic creating of parsing demarcations may be realized by a user electronically drawing vertical lines in the electronic portable document format file of image data.

The electronic identifying of labels may be realized by comparing a comma separated value with a table of values corresponding to labels.

The electronic identifying of data corresponding to each identified labels may be realized by identifying a non-label comma separated value located in a same row of an identified label comma separated value but a different column of the identified label comma separated value.

The electronic identifying of data corresponding to each identified labels may be realized by identifying a non-label comma separated value located in a different row of an identified label comma separated value but a same column of the identified label comma separated value.

A web based system for automatically converting an electronic portable document format file of image data into an electronic format compatible for importing into a database includes a remote computer; a server operably connected to the remote computer; and a local computer operably connected to the server; the remote computer uploading an electronic portable document format file of image data to the server; the local computer electronically creating, using a user input interface associated with the local computer, within the electronic portable document format file of image data, parsing demarcations, the server electronically converting the portable document format file of image data into an electronic comma separated values file of ASCII characters, based upon the created demarcations, using an optical character recognition process, the created parsing demarcations being used to locate commas in the created electronic comma separated values file of ASCII characters; the server electronically identifying, in the created electronic comma separated values file of ASCII characters, labels; the server electronically identifying, in the created electronic comma separated values file of ASCII characters, data corresponding to each identified labels; the server electronically associating the identified data with the corresponding identified label; and the server electronically inputting the associated identified data with the corresponding identified label into a database.

The electronic creating of parsing demarcations may be realized by a user electronically drawing vertical lines in the electronic portable document format file of image data.

The electronic identifying of labels may be realized by comparing a comma separated value with a table of values corresponding to labels.

The electronic identifying of data corresponding to each identified labels may be realized by identifying a non-label comma separated value located in a same row of an identified label comma separated value but a different column of the identified label comma separated value.

The electronic identifying of data corresponding to each identified labels may be realized by identifying a non-label comma separated value located in a different row of an identified label comma separated value but a same column of the identified label comma separated value.

It will be appreciated that variations of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the description above.

What is claimed is:

1. A method for automatically converting data printed on a physical document into an electronic format compatible for importing into a database comprising the steps of:
(a) optically scanning, using a scanner, the physical document having data printed thereon to create an electronic portable document format file of image data;
(b) electronically creating, using a user input interface, within the electronic portable document format file of image data, parsing demarcations;
(c) converting, using a computer operatively connected to the scanner, the portable document format file of image data into an electronic comma separated values file of ASCII characters, based upon the created demarcations, using an optical character recognition process, the created parsing demarcations being used to locate commas in the created electronic comma separated values file of ASCII characters;
(d) electronically identifying, in the created electronic comma separated values file of ASCII characters, labels;
(e) electronically identifying, in the created electronic comma separated values file of ASCII characters, data corresponding to each identified labels;
(f) electronically associating the identified data with the corresponding identified label; and
(g) electronically pushing the associated identified data with the corresponding identified label into a database.

2. The method as claimed in claim 1, wherein the electronic creating of parsing demarcations is realized by a user electronically drawing vertical lines in the electronic portable document format file of image data.

3. The method as claimed in claim 1, wherein the electronic identifying of labels is realized by comparing a comma separated value with a table of values corresponding to labels.

4. The method as claimed in claim 1, wherein the electronic identifying of data corresponding to each identified labels is realized by identifying a non-label comma separated value located in a same row of an identified label comma separated value but a different column of the identified label comma separated value.

5. The method as claimed in claim 1, wherein the electronic identifying of data corresponding to each identified labels is realized by identifying a non-label comma separated value located in a different row of an identified label comma separated value but a same column of the identified label comma separated value.

6. A method for automatically converting an electronic portable document format file of image data into an electronic format compatible for importing into a database comprising the steps of:
(a) receiving an electronic portable document format file of image data;
(b) electronically creating, using a user input interface, within the electronic portable document format file of image data, parsing demarcations;
(c) converting, using a computer, portable document format file of image data into an electronic comma separated values file of ASCII characters, based upon the created demarcations, using an optical character recognition process, the created parsing demarcations being used to locate commas in the created electronic comma separated values file of ASCII characters;
(d) electronically identifying, in the created electronic comma separated values file of ASCII characters, labels;
(e) electronically identifying, in the created electronic comma separated values file of ASCII characters, data corresponding to each identified labels;
(f) electronically associating the identified data with the corresponding identified label; and
(g) electronically pushing the associated identified data with the corresponding identified label into a database.

7. The method as claimed in claim 6, wherein the electronic creating of parsing demarcations is realized by a user electronically drawing vertical lines in the electronic portable document format file of image data.

8. The method as claimed in claim 6, wherein the electronic identifying of labels is realized by comparing a comma separated value with a table of values corresponding to labels.

9. The method as claimed in claim 6, wherein the electronic identifying of data corresponding to each identified labels is realized by identifying a non-label comma separated value located in a same row of an identified label comma separated value but a different column of the identified label comma separated value.

10. The method as claimed in claim 6, wherein the electronic identifying of data corresponding to each identified labels is realized by identifying a non-label comma separated value located in a different row of an identified label comma separated value but a same column of the identified label comma separated value.

11. A web based system for automatically converting an electronic portable document format file of image data into an electronic format compatible for importing into a database comprising:
a remote computer;
a server operably connected to said remote computer; and
a local computer operably connected to said server;
said remote computer uploading an electronic portable document format file of image data to said server;
said local computer electronically creating, using a user input interface associated with said local computer, within the electronic portable document format file of image data, parsing demarcations,
said server electronically converting said portable document format file of image data into an electronic comma separated values file of ASCII characters, based upon said created demarcations, using an optical character recognition process, said created parsing demarcations being used to locate commas in said created electronic comma separated values file of ASCII characters;
said server electronically identifying, in said created electronic comma separated values file of ASCII characters, labels;
said server electronically identifying, in said created electronic comma separated values file of ASCII characters, data corresponding to each identified labels;
said server electronically associating said identified data with said corresponding identified label; and
said server electronically inputting said associated identified data with said corresponding identified label into a database.

12. The web based system as claimed in claim 11, wherein said local computer electronically creates said parsing demarcations by a user electronically drawing vertical lines in said electronic portable document format file of image data.

13. The web based system as claimed in claim 11, wherein said server identifies labels by comparing a comma separated value with a table of values corresponding to labels.

14. The web based system as claimed in claim 11, wherein said server identifies data corresponding to each identified labels by identifying a non-label comma separated value located in a same row of an identified label comma separated value but a different column of the identified label comma separated value.

15. The web based system as claimed in claim 11, wherein said server identifies data corresponding to each identified labels by identifying a non-label comma separated value located in a different row of an identified label comma separated value but a same column of the identified label comma separated value.
